(19) United States
(12) Patent Application Publication
(10) Pub. No.: US 2021/0286979 A1
(43) Pub. Date: Sep. 16, 2021

(54) IDENTITY VERIFICATION METHOD AND DEVICE, ELECTRONIC DEVICE AND COMPUTER-READABLE STORAGE MEDIUM

(71) Applicant: SHENZHEN SENSETIME TECHNOLOGY CO., LTD., Shenzhen (CN)

(72) Inventors: Shijie ZHUANG, Shenzhen (CN); Wenzhong JIANG, Shenzhen (CN); Hongbin ZHAO, Shenzhen (CN)

(21) Appl. No.: 17/329,538

(22) Filed: May 25, 2021

Related U.S. Application Data
(63) Continuation of application No. PCT/CN2020/100639, filed on Jul. 7, 2020.

(30) Foreign Application Priority Data
Sep. 26, 2019 (CN) 201910918439.5

(51) Int. Cl. G06K 9/00; G07C 9/22

(52) U.S. Cl. CPC G06K 9/00288; G07C 9/22

(57) ABSTRACT

An identity verification method and device and a storage medium are provided. The method includes that: a face image of an object to be verified is acquired; responsive to the condition that the face image is included in a predetermined face image library, a target verification mode for the object to be verified is acquired; and the object to be verified is verified according to the target verification mode to obtain a verification result.

### CROSS-REFERENCE TO RELATED APPLICATION

The present application is a continuation application of International Patent Application No. PCT/CN2020/100639, filed on Jul. 7, 2020, which is filed based upon and claims priority to Chinese Patent Application No. 201910918439.5, filed on Sep. 26, 2019, and entitled “Identity Verification Method and Device, Electronic Device and Storage Medium”. The disclosures of International Patent Application No. PCT/CN2020/100639 and Chinese Patent Application No. 201910918439.5 are hereby incorporated by reference in their entireties.

### BACKGROUND

Identity verification is applied to more and more scenarios. For example, identity verification may be applied to authentication verification of a target user, verification of a credit information system and the like. For example, in a scenario of authentication verification of a target user, admission or restriction for the target user may be set in any case of a staff office, a meeting room, machine room maintenance and the like. However, in a related art, the security of admission or restriction for a target user is relatively low.

### SUMMARY

The disclosure relate to the technical field of computer vision, and relates, but is not limited, to a method and device for identity verification, an electronic device and a computer-readable storage medium.

In some embodiments, an identity verification method is provided. The method may include the following operations. A face image of an object to be verified is acquired. Responsive to the condition that the face image is included in a predetermined face image library, a target verification mode for the object to be verified is acquired. The object to be verified is verified according to the target verification mode to obtain a verification result.

In some embodiments, an electronic device is provided. The device may include: a processor; and a memory configured to store instructions executable for the processor. The processor may be configured to execute the identity verification method.

In some embodiments, a non-transitory computer-readable storage medium is provided, the non-transitory computer-readable storage medium has stored computer program instructions that when executed by a processor, implement the identity verification method.

### BRIEF DESCRIPTION OF THE DRAWINGS

The accompanying drawings, which are incorporated in and constitute a part of this Description, illustrate embodiments consistent with the disclosure and, together with the Description, serve to describe the technical solutions of the disclosure.

FIG. 1 is an architecture diagram of an identity verification system 100 according to one or more embodiments.

FIG. 2 is a flowchart of an identity verification method according to one or more embodiments.

FIG. 3 is a schematic diagram of identity information in an identity verification method according to one or more embodiments.

FIG. 4 is a flowchart of an identity verification method according to one or more embodiments.

FIG. 5 is a flowchart of another identity verification method according to one or more embodiments.

FIG. 6 is a flowchart of another identity verification method according to one or more embodiments.

FIG. 7 is a block diagram of an identity verification device according to one or more embodiments.

FIG. 8 is a block diagram of an electronic device 800 according to one or more embodiments.

FIG. 9 is a block diagram of another electronic device 900 according to one or more embodiments.

### DETAILED DESCRIPTION

Each exemplary embodiment, feature and aspect of the disclosure will be described below with reference to the drawings in detail. The same reference signs in the drawings represent components with the same or similar functions. Although various aspects of the embodiments are illustrated in the drawings, the drawings are not necessarily drawn to scale, unless otherwise specified.

Herein, special term “exemplary” refers to “use as an example, embodiment or description”. Herein, any “exemplarily” described embodiment may not be explained to be superior to or better than other embodiments.

In the disclosure, term “and/or” is only an association relationship describing associated objects and represents that three relationships may exist. For example, A and/or B may represent three conditions: i.e., independent existence of A, existence of both A and B and independent existence of B. In addition, term “at least one” in the disclosure represents any one of multiple or any combination of at least two of multiple. For example, including at least one of A, B and C may represent including any one or more elements selected from a set formed by A, B and C.

In addition, for describing the disclosure better, many specific details are presented in the following specific implementations. It is understood by those skilled in the art that the disclosure may still be implemented even without some specific details. In some examples, methods, means, components and circuits known very well to those skilled in the art are not described in detail, to highlight the subject of the disclosure.

Identity verification may be applied to scenarios of authentication verification of a target object, verification of a credit information system and the like. In a scenario of authentication verification of a target object, admission or restriction for the target object may be set in different regions, for example, in any case of a staff office, a meeting room and machine room maintenance. Different regions have different specific requirements on admission or restriction. Under the limit of a condition of a present hardware device, for example, if the hardware device is a face recognizer, authentication verification is performed on the target object in a face recognition manner, so that the hardware device may be applied to undiversified scenarios. In one or more embodiments, the hardware device may be extended through a hardware interface. For example, identity information is read through an external identification card reader (for example, information and portrait in an identity card are read). For example, the identification card reader is connected to the identity verification device through a Universal Serial Bus (USB) interface.

In some embodiments, for different regions, verification modes for admission or restriction of different security levels may be set. Since an external face collector may be connected to the identity verification device, the external identification card reader may be connected to the identity verification device, a face image of an object to be verified may be connected through the external face collector and identity information may be read through the external identification card reader (for example, user information and user portrait in an identity card are read), in one or more embodiments, the identity verification of the object may be assisted through the introduced identity information, and in case that a verification result is that verification succeeds, access of the object to be verified to a target region may be allowed. Therefore, the security of admission or restriction for the target object may be improved.

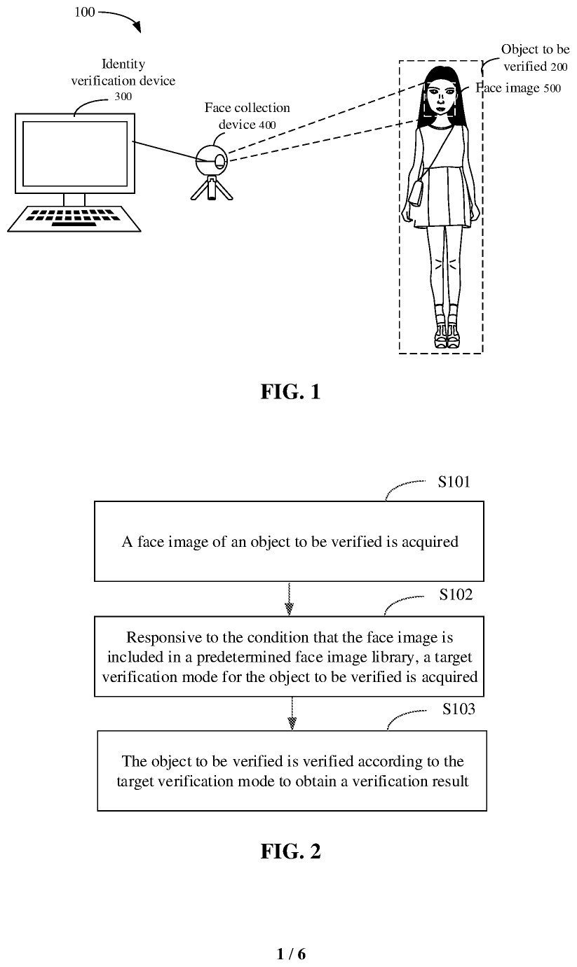

FIG. 1 is an architecture diagram of an identity verification system 100 according to one or more embodiments. Referring to FIG. 1, in case that there is an object to be verified 200, an identity verification device 300 may acquire a face image 500 of the object to be verified 200 through a face collection device 400, for example, a camera, acquire a target verification mode for the object to be verified responsive to a condition that face image 500 is in a predetermined face image library and finally verify the object to be verified according to the target verification mode to obtain a verification result, thereby controlling admission or restriction for the object to be verified.

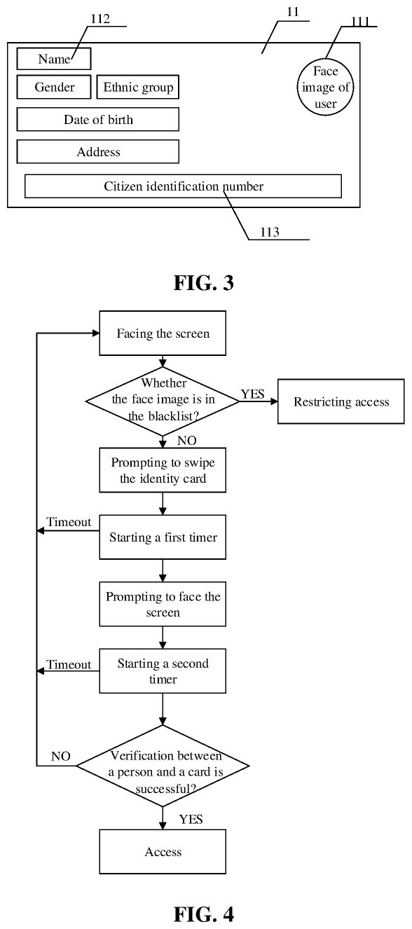

FIG. 2 is a flowchart of an identity verification method according to one or more embodiments. The method is applied to an identity verification device. For example, in case that the device is deployed in a terminal device or a server or another processing device, image classification, image detection, video processing and the like may be executed. The terminal device may be User Equipment (UE), a mobile device, a cell phone, a cordless phone, a Personal Digital Assistant (PDA), a handheld device, a computing device, a vehicle device, a wearable device and the like. In some embodiments, the identity verification method may be implemented in a manner that a processor calls a computer-readable instruction stored in a memory. As illustrated in FIG. 1, the flow includes the following steps.

In S101, a face image of an object to be verified is acquired.

In some embodiments, the identity verification device may acquire the face image of the object to be verified responsive to a face collection operation.

The embodiment is implemented in case that identity verification is required to be performed on the object to be verified (for example, an employee that clocks in and out, an attendee that attends a meeting, a maintainer accesses a machine room for maintenance and a specified region with a high security permission). The identity verification device may perform face collection through a terminal device such as a camera to obtain the face image of the object to be verified. For example, the identity verification device executes the face collection operation by use of an image collection device, such as a camera and a capturing device, set on a face collector, thereby acquiring the face image of the object to be verified.

In S102, responsive to the condition that the face image is included in a predetermined face image library, a target verification mode for the object to be verified is acquired.

In some embodiments, the predetermined face image library is a non-blacklist library, and the non-blacklist library may include a white list and unregistered objects. In the embodiment, a blacklist includes those defined to be prohibited by a manager, for example, takeaway deliverers or couriers.

The operation that the identity verification device acquires the target verification mode for the object to be verified responsive to the condition that the face image is included in the predetermined face image library is described below.

In a first scenario, in case that the face image is included in the predetermined face image library, the identity verification device determines verification according to identity information as the target verification mode.

If the face image is included in the predetermined face image library, it is indicated that the object to be verified is not in the blacklist. In such case, the identity verification device may directly set the target verification mode to be verifying identity information of the object to be verified to determine whether the object to be verified may be managed through a door.

In a second scenario, in case that the face image is included in the predetermined face image library, the identity verification device judges whether the face image is included in a target face image library to obtain a determination result, and the identity verification device acquires the target verification mode according to the determination result.

In case that the determination result is that the face image is not included in the target face image library, the identity verification device determines verification according to the identity information as the target verification mode.

Under this condition, the identity verification device may be set in a place with a relatively low door access restriction, for example, nearby a work attendance point. In case that the face image of the object to be verified is included in the predetermined face image library, for improving the security, the identity verification device is also set with the target face image library, the target face image library storing face images of objects with relatively high access permissions. When the face image of the object to be verified does not belong to the blacklist and is included in the target face image library, it is indicated that the object to be verified has a relatively high access permission and the object to be verified may directly access. When the face image of the object to be verified does not belong to the blacklist and is not included in the target face image library, namely the object to be verified does not have any access permission, since the door access restriction of the place is relatively low, the identity verification device may directly verify an identity of the object to be verified by use of the identity information of the object to be verified. In such case, identity verification is equivalently performed twice on the object to be verified to improve the security of the place.

In a third scenario, in case that the face image is included in the predetermined face image library, the identity verification device judges whether the face image is included in the target face image library to obtain the determination result, and the identity verification device may acquire the target verification mode according to the determination result.

In case that the determination result is that the face image is included in the target face image library, the identity verification device determines verification according to the identity information as the target verification mode.

In the third scenario, the identity verification device may be set in a place with a relatively high door access permission, for example, at a door of a meeting room and at a door of a maintained machine room. In case that the face image of the object to be verified is included in the predetermined face image library and is simultaneously included in the target face image library, it is indicated that the object to be verified has a relatively high access permission and namely may access the place with the relatively high door access permission. In such case, the identity verification device may prompt the object to be verified for identity verification, thereby implementing identity verification by use of the identity information of the object to be verified to obtain a verification result. In case that the face image is included in the predetermined face image library but is not included in the target face image library, the identity verification device may not prompt the object to be verified for identity verification, namely the identity verification device directly restricts the object to be verified to completely eradicate the probability of access of the object to be verified with a relatively low access permission to the place with the relatively high door access permission and ensure the security of the place with the relatively high door access permission.

In S103, the object to be verified is verified according to the target verification mode to obtain a verification result.

Different regions have different specific requirements on admission or restriction for the object to be verified, and the identity verification device may select a corresponding target verification mode for verification according to a region that the object to be verified accesses. In some embodiments, the face image of the object to be verified is verified in the region that the object to be verified accesses according to the target verification mode to obtain the verification result, the verification result indicating whether the object to be verified passes identity verification. The verification result may be a comparison result obtained by verifying the face image and a pre-stored face image in an identification card.

According to some embodiments, the identity verification device may determine whether the collected face image of the object to be verified is included in the predetermined face image library to determine whether to acquire the target verification mode, and in case that the face image is included in the predetermined face image library, the identity verification device acquires the target verification mode and verifies the object to be verified according to the target verification mode to obtain the verification result, thereby determining whether to open the door to allow access of the object to be verified that is successfully verified to a target region. Therefore, according to the identity verification method provided in the embodiment, the security of admission or restriction for a target object may be improved, furthermore, the security is improved, and security level requirements of different scenarios are met.

Different regions have different specific requirements on admission or restriction, and the identity verification device may verify the object to be verified according to the target verification mode. Descriptions are made below with examples.

For example, in case that the object to be verified is an employee that clocks in and out, the identity verification device may compare the collected face image and a preset face image in a face recognition library (specifically, an image feature of the collected face image may be compared with an image feature of the preset face image) to verify the object to be verified.

For another example, in case that the object to be verified is an attendee that attends a meeting, if the meeting is a general meeting, it is only necessary to perform verification according to the preset face image. If the meeting is a high-level meeting or a meeting involving technology secrets before release or launching of products, for avoiding the secrets being divulged, it is necessary to restrict attendees, and the identity verification device is required to verify identity information of the attendees to improve the security. In case that a general meeting is held at 9:00 to 10:00 and a high-level meeting is held at 16:00 to 17:00 in the same meeting room, according to a setting of whether a security level of the meeting is a general level or a high level, the identity verification device may perform verification according to the preset face image or perform verification according to the identity information.

For another example, when the object to be verified is a maintainer accessing a machine room for maintenance, for such a region where a failure is likely to bring significant influence such as a specified region with a high security permission, a security level thereof is higher, and the identity verification device may perform verification according to the preset face image and the identity information to achieve security higher than that in the abovementioned scenario.

After S103, the following operation may further be included: a control signal is generated according to the verification result, and access through a door is controlled according to the control signal.

The identity verification device, after completing verifying the object to be verified to obtain the verification result, may further control whether to open the door according to the verification result, thereby determining whether the object to be verified may pass. In case that the verification result indicates that the object to be verified passes identity verification, the identity verification device may generate a signal for controlling the door to be opened to enable the object to be verified passing identity verification to pass the door. In case that the verification result indicates that the object to be verified does not pass identity verification, the identity verification device may not generate the signal for controlling the door to be opened such that the door is kept in a closed state and the object to be verified that does not pass identity verification may not pass through the door.

In some embodiments, the identity information may be stored in the identification card of the object to be verified. For the identity information, FIG. 3 is a schematic diagram of identity information in an identity verification method according to one or more embodiments. The identity verification device of some embodiments may be connected with an extended face recognizer through a hardware interface. For example, the face recognizer is connected to the identity verification device through a USB interface to recognize the identity information.

It is to be pointed out that the identification card includes, but not limited to, an identity card. Descriptions are made with reference to FIG. 3 with an identity card as an example. The identity card 11 includes a face image 111 of an object, detailed information 112 of the object such as the “name”, the “gender”, the “ethnic group”, the “date of birth” and the “address”, and object identification code information 113 such as “citizen identification number”. Therefore, besides comparison between a collected face image and a preset image, the face image, extracted from the identity card, of the object may further be compared with a preset face image in the face recognition library to verify that an object that face collection is being performed on and the object on the identity card are the same person, so that the security is further improved.

In one or more embodiments, verification may also be performed in combination with comparison of the face images according to the detailed information of the object such as the “name”, the “gender”, the “ethnic group”, the “date of birth” and the “address” to confirm an identity of the object.

An external identification card reader may be connected to the identity verification device through a USB interface to extend an identity card reading function of the identity verification device, so that the customizability of the identity verification device for identity verification is improved, the security may also be improved, and verification requirements of different scenarios may be met. For example, in some embodiments, in a scenario such as a hotel and a library, an object may access in manners of swiping an identity card, swiping the face or the identity card and swiping both the card and the identity card, so that the security and the access efficiency are improved.

In at least some embodiments, for different regions, verification modes for admission or restriction of different security levels may be set. Under the condition of not modifying hardware, the external identification card reader may be connected to the identity verification device through the USB interface to support swiping of the identity card and read the identity information (for example, the detailed information of the object and portrait of the object in the identity card are read).

In some embodiments, the identity information includes the pre-stored face image of the object to be verified and detailed information of the object to be verified. In case that the target verification mode is verification according to the identity information, the operation that the identity verification device verifies the object to be verified according to the target verification mode to obtain the verification result includes that: the identity information in the identification card of the object to be verified is acquired, and the pre-stored face image is extracted from the identity information; the face image is compared with the pre-stored face image to obtain a comparison result; and the verification result is obtained according to the comparison result.

The identity verification device, when comparing the face image and the pre-stored face image, may extract a face feature in the face image and a pre-stored face feature in the pre-stored face image by use of a feature extraction algorithm and then calculate a similarity between the face feature and the pre-stored face feature. In case that the similarity between the face feature and the pre-stored face feature is greater than a similarity threshold, for example, in case that the similarity is greater than 80%, the comparison result obtained by the identity verification device is that the face image and the pre-stored face image belong to the same object. In case that the comparison result indicates that the face image and the pre-stored face image belong to the same object, the identity verification device may obtain a verification result indicating that verification succeeds. On the contrary, in case that the comparison result indicates that the face image and the pre-stored face image do not belong to the same object, the identity verification device may obtain a verification result indicating that verification fails.

In some embodiments, the identity information may also be preset fingerprint information stored in a chip of the identification card of the object to be verified. Under the condition of not modifying the hardware, the identity verification device is connected with an extended fingerprint scanner through a hardware interface to collect fingerprint information of the object to be verified through the fingerprint scanner, and then compares the fingerprint information extracted from the identification card and the fingerprint information collected through the fingerprint scanner to obtain a comparison result, thereby obtaining the verification result according to the comparison result.

In the embodiment, the operation that the identity verification device acquires the identity information in the identification card of the object to be verified includes that: an information prompt is triggered, and the identity information in the identification card is started to be read through a card reader. Triggering the information prompt may refer to providing related prompting information of swiping the identity card, and the identity verification device may give a text or voice prompt, etc.

After the identity verification device triggers the information prompt and reads the identity information in the identification card through the card reader, the method further includes that: for processing of reading the identity information through the card reader, timing processing is started to obtain a time length of reading the identity information through the card reader; and responsive to the time length reaching first predetermined time, the information prompt is turned off. That is, the identity verification device, after triggering the information prompt, starts a timer to monitor a reading operation of the card reader over the identity information. In case that the time length reaches the first predetermined time, the identity verification device may turn off the prompting information for the present reading operation. For example, the identity verification device monitors the reading operation of the card reader over the identity information through the timer. If the identity information is not read when the first predetermined time is reached, the identity verification device may turn off the prompt of swiping the identity card and restart an identity verification flow, namely another face image of the object to be verified is collected through an external face collection device and the target verification mode for the object to be verified is further acquired according to the condition of whether the face image is in the predetermined face image library.

It can be understood that the first predetermined time may be set according to a practical requirement. For example, it is set to be 2 s or set to be 5 s. No limits are made thereto in one or more embodiments.

In some embodiments, the operation that the identity verification device triggers the information prompt includes that: preset prompting information is presented on a display interface to trigger the information prompt. The preset prompting information may be voice prompting information and may also be text prompting information, such as prompting information “swipe the identity card”.

After the identity verification device triggers the prompting information and reads the pre-stored face image through the card reader, the method further includes that: a face collection operation is continued to be executed, timing processing of the timer is started, and responsive to the condition that a time length reaches second predetermined time, the present face image collection operation is stopped.

The identity verification device, after reading the pre-stored face image of the object to be verified from the identification card, is further required to collect face information of the object to be verified to verify the object to be verified through the face. In such case, the identity verification device shoots the object to be verified by use of the image collection device, such as the camera and the capturing device, set on the face collector and then extracts the face image of the object to be verified from a shot image to implement the face collection operation over the object to be verified. For preventing the condition that the object to be verified has left a shooting range of the face recognizer while the identity verification device keeps collecting the face of the object to be verified through the face recognizer and thus is unlikely to restart performing identity verification on the object to be verified, the identity verification device may simultaneously start the timer to control a time length of collecting the face image of the object to be verified through the face recognizer in case that the pre-stored face image is read through the card reader. In case that the time length of the timer reaches the second predetermined time, the identity verification device may control the face recognizer to stop face collection to facilitate subsequent restarting of identity verification work over the object to be verified.

It can be understood that the second predetermined time may also be set according to the practical requirement. For example, the second predetermined time is set to be 3 s and even 10 s. No specific limits are made thereto in one or more embodiments.

It is to be pointed out that the external identification card reader of one or more embodiments supports hot plugging. Hot plugging refers to that: when the external identification card reader is connected to the identity verification device through the USB interface, the extended identity card reading function of the identity verification device is supported, so that the customizability of the identity verification device for verification is improved; and when the external identification card reader is unplugged from the identity verification device, the extended identity card reading function of the identity verification device is canceled. Such an extension does not require the hardware of the identity verification device to be improved and thus may not increase the cost, the whole card reading flow is simple and easy, and compared with improving the hardware of the identity verification device, the extension has the advantage that the card reading speed of the card reader is increased.

It can be understood by those skilled in the art that, in the method of the specific implementations, the writing sequence of each step does not mean a strict execution sequence and is not intended to form any limit to the implementation process and a specific execution sequence of each step should be determined by functions and probable internal logic thereof.

Each method embodiment mentioned in one or more embodiments may be combined to form combined embodiments without departing from principles and logics. For saving the space, elaborations are omitted in one or more embodiments.

An application example of the embodiment in a practical application scenario will be introduced below.

Hardware facilities (the identity verification device, the external face collection device and the external identification card reader) mentioned in one or more embodiments are deployed in a specified target region. Identity verification is performed according to a page prompt of, for example, prompting an object to be verified to face a screen for face collection and/or swipe an identity card for access. If no face is detected or no identity card is swiped in a timing length (defaulting to 10 s) of a timer, the timer is reset, and timing processing of the timer is restarted.

FIG. 4 is a flowchart of an identity verification method according to one or more embodiments. After a face image is collected, an identity of the object to be verified is verified only in an identification card verification manner. The following contents are included.

The identity verification device prompts the object to be verified to face the screen to collect the face image of the object to be verified. In case that the object to be verified faces the screen, the identity verification device collects the face image of the object to be verified by use of a camera of a face collector and determines whether the face image of the object to be verified in a blacklist. In case that the face image of the object to be verified is in the blacklist, the identity verification device directly restricts access of the object to be verified. In case that the face image of the object to be verified is not in the blacklist, it is indicated that the face image is in a predetermined face image library (i.e., a non-blacklist library), the identity verification device may give a prompt of swiping the identity card for identity verification. Meanwhile, the identity verification device turns on the external identification card reader to start reading identity information and starts collecting a face image of the object to be verified. Herein the face image may be an image when the object to be verified faces the camera and may also be a profile image of the object to be verified or an image when the object to be verified lowers the head. After the object to be verified swipes the identity card, the identification card reader reads the identity information in the identity card, namely a pre-stored face image in the identity card is read. The identity verification device compares the pre-stored face image and the collected face image to obtain a comparison result. When the comparison result is greater than a preset threshold, Verification between a person and a card is successful, and the identity verification device controls a door to allow access of the object to be verified. When the comparison result is less than or equal to the preset threshold, human-card verification fails, and the identity verification device prompts the object to be verified to face the screen again to restart identity verification. The object to be verified may be one object that face collection is performed on, and may also be multiple objects that face collection is sequentially or simultaneously performed on.

The identity verification device, when prompting the object to be verified to swipe the identity card, may set and start a first timer to perform timing processing on an identity card swiping action of the object to be verified. In case that a time length reaches first predetermined time, if the identity verification device does not receive a triggering signal for identity card information collection, namely in case of an identity card information collection timeout, the identity verification device may prompt the object to be verified to perform face collection again to restart identity verification. Under this condition, the first timer is configured to monitor when to turn off the prompt for identity card information collection. In another possible implementation mode, after the identity verification device prompts the object to be verified to perform face image collection, namely prompting the object to be verified to face the screen, the following operation may further be included: a second timer is set and started for timing processing. In case that no object to be verified is detected if a time length reaches second predetermined time, namely in case of a face collection timeout, a present face image collection operation is stopped, and the object to be verified is prompted again to face the screen to restart identity verification. Under this condition, the second timer is configured to monitor when to stop the present face image collection operation.

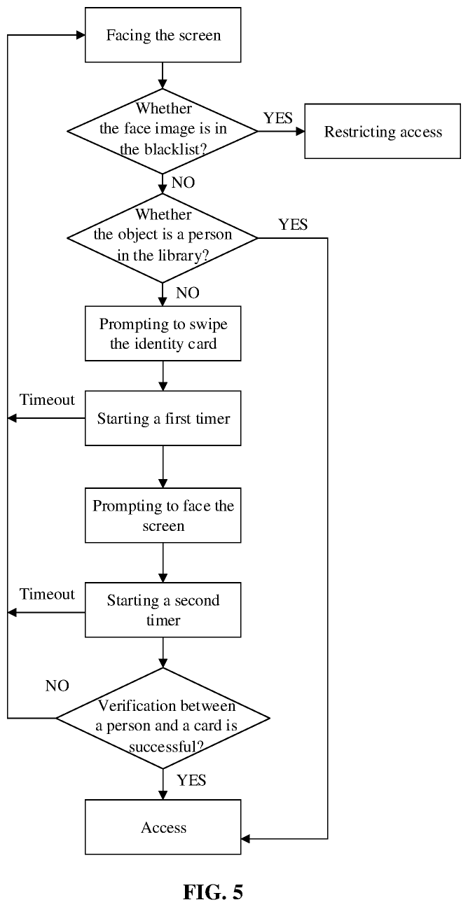

FIG. 5 is a flowchart of another identity verification method according to one or more embodiments. The identity verification device prompts the object to be verified to face the screen to collect the face image of the object to be verified. In case that the object to be verified faces the screen, the identity verification device, after determining whether the face image of the object to be verified is in a target face image library, namely after determining whether the face image of the object to be verified is in the blacklist, determines whether to prompt identity card verification according to a determination result. In case that the face image is in the target face image library, access is allowed without swiping the identity card. In case that the face image is not in the target face image library, the identity verification device prompts the object to be verified to swipe the identity card for verification, and access is allowed only when identity card verification succeeds. The following contents are included.

The identity verification device collects the face image of the object to be verified, determines whether the face image of the object to be verified is in the blacklist, and if it is in the blacklist, directly restricts access.

If the face image of the object to be verified is not in the blacklist, it is indicated that the face image of the object to be verified is in the predetermined face image library (i.e., the non-blacklist library), and the identity verification device judges whether the face image of the object to be verified is in the target face image library, namely determining whether the object to be verified is a person in the library. In case that a determination result is NO, the identity verification device may prompt the object to be verified to swipe the identity card for identity verification. In case that the determination result is YES, the identity verification device may control the door to allow access of the object to be verified. Meanwhile, the identity verification device turns on the external identification card reader to start reading identity card information. After the object to be verified swipes the identity card, the identification card reader reads the identity information in the identity card, and the object to be verified is prompted to face the screen to collect the face image of the object to be verified. The identity verification device compares the pre-stored face image in the identity information and the collected face image to obtain the comparison result. In case that the comparison result is greater than the preset threshold, Verification between a person and a card is successful, and access of the object to be verified is allowed. When the comparison result is less than or equal to the preset threshold, human-card verification fails, and the object to be verified is prompted again to face the screen again to restart an identity verification process. The object to be verified may be one object that face collection is performed on, and may also be multiple objects that face collection is sequentially or simultaneously performed on.

The identity verification device, when prompting the object to be verified to swipe the identity card and starting acquiring the identity information of the object to be verified, may set the first timer and start the first timer for timing. In case that the triggering signal for identity card information collection is not received in predetermined time, namely in case of the identity card information collection timeout, the identity verification device may prompt the object to be verified to face the screen to perform face collection again to restart an identity verification process.

In case that the identity verification device initially prompts the object for face collection, the following operation may further be included: the object to be verified is prompted to face the screen, the second timer is set, and the second timer is started for timing. If it is detected that no object to be verified is in front of the face collector in the predetermined time, namely in case of the face collection timeout, the present face collection operation is stopped, and the object to be verified is prompted again to face the screen to restart the identity verification process. The first timer is configured to monitor when to turn off the prompt for identity card information collection, and the second timer is configured to monitor when to stop the present collection operation.

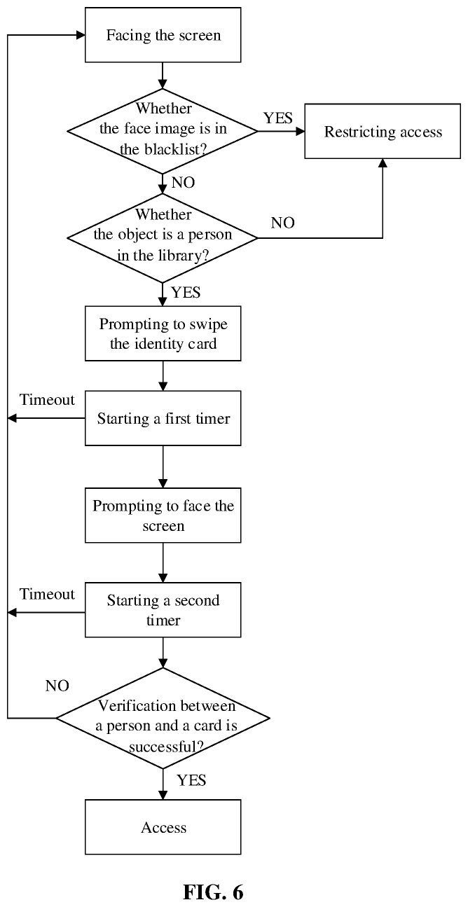

FIG. 6 is a flowchart of another identity verification method according to one or more embodiments. The identity card is swiped according to the prompt after whether the face image is in the target face image library is determined, which is applied to access to a region requiring a higher permission. The following contents are included.

The identity verification device prompts the object to be verified to face the screen to collect the face image of the object to be verified. In case that the object to be verified faces the screen, the face image of the object to be verified is collected, whether the face image of the object to be verified is in the blacklist is determined, and if it is in the blacklist, access is directly restricted.

If the face image of the object to be verified is not in the blacklist, it is indicated that the face image of the object to be verified is in the predetermined face image library (i.e., the non-blacklist library), and the identity verification device judges whether the face image of the object to be verified is in the target face image library, namely determining whether the object to be verified is a person in the library. In case that the determination result is YES, the identity verification device may prompt the object to be verified to swipe the identity card for identity verification and prompt the object to be verified to face the screen to collect the face image of the object to be verified. The identity verification device turns on the external identification card reader to start reading the identity card information. After the object to be verified swipes the identity card, the identification card reader reads the identity information in the identity card, and the identity verification device compares pre-stored face information in the identity information and the face image collected by the face collector to obtain the comparison result. In case that the comparison result is greater than the preset threshold, Verification between a person and a card is successful, and the identity verification device controls the door to be opened to allow access of the object to be verified. In case that the comparison result is less than or equal to the preset threshold, human-card verification fails, and the identity verification device may prompt the object to be verified again to face the screen to restart an identity verification process. The object to be verified may be one object that face collection is performed on, and may also be multiple objects that face collection is sequentially or simultaneously performed on.

The identity verification device, when prompting the object to be verified to swipe the identity card, may start the first timer for timing In case that the triggering signal for identity card information collection is not received in predetermined time, namely in case of the identity card information collection timeout, the identity verification device may prompt the object to be verified to face the screen to restart identity verification.

In case that the identity verification device initially prompts the object for face collection, the following operation may further be included: the second timer is set and started. If no object to be verified is detected in the predetermined time, namely in case of the face collection timeout, the present face image collection operation is stopped, and the object to be verified is prompted again to face the screen to restart identity verification.

In addition, one or more embodiments also provide an identity verification device, an electronic device, a computer-readable storage medium and a program. All of them may be configured to implement any identity verification method provided in one or more embodiments. Corresponding technical solutions and descriptions refer to the corresponding records in the method part and will not be elaborated.

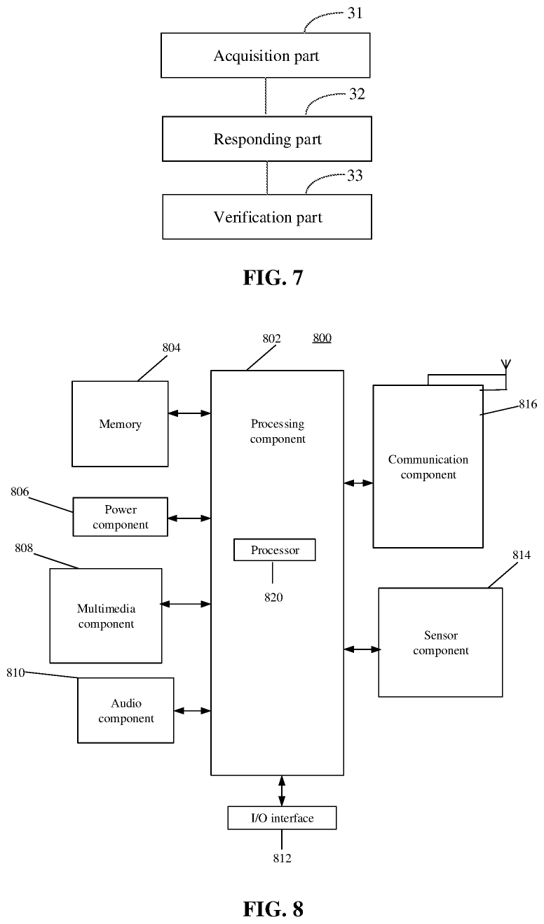

FIG. 7 is a block diagram of an identity verification device according to one or more embodiments. As illustrated in FIG. 7, the identity verification device includes: an acquisition part 31, configured to acquire a face image of an object to be verified; a responding part 32, configured to, responsive to the condition that the face image is included in a predetermined face image library, acquire a target verification mode for the object to be verified; and a verification part 33, configured to verify the object to be verified according to the target verification mode to obtain a verification result.

In some embodiments, the responding part 32 is configured to, in case that the face image is included in the predetermined face image library, determine verification according to identity information as the target verification mode.

In some embodiments, the responding part 32 is configured to, in case that the face image is included in the predetermined face image library, determine whether the face image is included in a target face image library to obtain a determination result and acquire the target verification mode according to the determination result.

In some embodiments, the responding part 32 is configured to, in case that the determination result is that the face image is not included in the target face image library, determine verification according to the identity information as the target verification mode.

In some embodiments, the responding part 32 is configured to, in case that the determination result is that the face image is included in the target face image library, determine verification according to the identity information as the target verification mode.

In some embodiments, the responding part 32 is configured to acquire the identity information in an identification card of the object to be verified, extract a pre-stored face image from the identity information, compare the face image and the pre-stored face image to obtain a comparison result and obtain the verification result according to the comparison result.

In some embodiments, the responding part 32 is configured to trigger an information prompt and read the identity information in the identification card through a card reader.

In some embodiments, the identity verification device further includes an information prompt control part, configured to, for processing of reading the identity information through the card reader, start timing processing to obtain a time length of reading the identity information through the card reader and, responsive to the time length reaching first predetermined time, turn off the information prompt.

In some embodiments, the identity verification device further includes a door control part, configured to generate a control signal according to the verification result and control access through a door according to the control signal.

In some embodiments, the responding part 32 is configured to present preset prompting information on a display interface to trigger the information prompt.

In some embodiments, functions or modules of the identity verification device provided in the embodiment may be configured to execute the method described in the method embodiment and specific implementation thereof may refer to the descriptions about the identity verification method embodiment and, for simplicity, will not be elaborated herein.

It is to be noted that, when being implemented in form of software functional module and sold or used as an independent product, the integrated module of the embodiments may also be stored in a computer storage medium.

One or more embodiments also disclose a computer-readable storage medium, in which a computer program instruction is stored, the computer program instruction being executed by a processor to implement the identity verification method. The computer-readable storage medium may be a nonvolatile computer-readable storage medium.

The identity verification device provided in one or more embodiments may be configured in a hardware device such as an electronic device.

One or more embodiments also disclose an electronic device, which includes a processor and a memory configured to store instructions executable for the processor, the processor being configured for the identity verification method.

The electronic device may be provided as a terminal, a server or a device in another form.

FIG. 8 is a block diagram of an electronic device 800 according to one or more embodiments. For example, the electronic device 800 may be a terminal such as a mobile phone, a computer, a digital broadcast terminal, a messaging device, a gaming console, a tablet, a medical device, exercise equipment and a PDA.

Referring to FIG. 8, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the steps in the identity verification method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the electronic device 800. Examples of such data include instructions for any application programs or methods operated on the electronic device 800, contact data, phonebook data, messages, pictures, video, etc. The memory 804 may be implemented by a volatile or nonvolatile storage device of any type or a combination thereof, for example, a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk.

The power component 806 provides power for various components of the electronic device 800. The power component 806 may include a power management system, one or more power supplies, and other components associated with generation, management and distribution of power for the electronic device 800.

The multimedia component 808 includes a screen providing an output interface between the electronic device 800 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. The touch sensors may not only sense a boundary of a touch or swipe action but also detect a duration and pressure associated with the touch or swipe action. The front camera and/or the rear camera may receive external multimedia data when the electronic device 800 is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 includes a Microphone (MIC), and the MIC is configured to receive an external audio signal when the electronic device 800 is in the operation mode, such as a call mode, a recording mode and a voice recognition mode. The received audio signal may further be stored in the memory 804 or sent through the communication component 816. In some embodiments, the audio component 810 further includes a speaker configured to output the audio signal.

The I/O interface 812 provides an interface between the processing component 802 and a peripheral interface module, and the peripheral interface module may be a keyboard, a click wheel, a button and the like. The button may include, but not limited to: a home button, a volume button, a starting button and a locking button.

The sensor component 814 includes one or more sensors configured to provide status assessment in various aspects for the electronic device 800. For instance, the sensor component 814 may detect an on/off status of the electronic device 800 and relative positioning of components, such as a display and small keyboard of the electronic device 800, and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device 800 and another device. The electronic device 800 may access a communication-standard-based wireless network, such as a Wireless Fidelity (Wi-Fi) network, a 2nd-Generation (2G) or 3rd-Generation (3G) network or a combination thereof. In an exemplary embodiment, the communication component 816 receives a broadcast signal or broadcast associated information from an external broadcast management system through a broadcast channel In an exemplary embodiment, the communication component 816 further includes a Near Field Communication (NFC) module to facilitate short-range communication. For example, the NFC module may be implemented based on a Radio Frequency Identification (RFID) technology, an Infrared Data Association (IrDA) technology, an Ultra-Wide Band (UWB) technology, a BlueTooth (BT) technology and another technology.

In the exemplary embodiment, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the identity verification method.

In the exemplary embodiment, a nonvolatile computer-readable storage medium is also provided, for example, a memory 804 including a computer program instruction. The computer program instruction may be executed by a processor 820 of an electronic device 800 to implement the identity verification method.

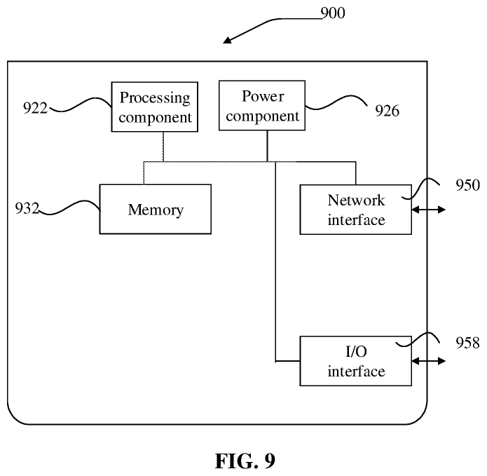

FIG. 9 is a block diagram of another electronic device 900 according to one or more embodiments. For example, the electronic device 900 may be provided as a server. Referring to FIG. 8, the electronic device 900 includes a processing component 922, further including one or more processors, and a memory resource represented by a memory 932, configured to store an instruction executable for the processing component 922, for example, an application program. The application program stored in the memory 932 may include one or more than one module of which each corresponds to a set of instructions. In addition, the processing component 922 is configured to execute the instruction to execute the identity verification method.

The electronic device 900 may further include a power component 926 configured to execute power management of the electronic device 900, a wired or wireless network interface 950 configured to concatenate the electronic device 900 to a network and an I/O interface 958. The electronic device 900 may be operated based on an operating system stored in the memory 932, for example, Windows Server™, Mac OS X™, Unix™, Linux™, FreeBSD™ or the like.

In the exemplary embodiment, a nonvolatile computer-readable storage medium is also provided, for example, a memory 932 including a computer program instruction. The computer program instruction may be executed by a processing component 922 of an electronic device 900 to implement the abovementioned method.

According to one or more embodiments, a system, a method and/or a computer program product is disclosed. The computer program product may include a computer-readable storage medium, in which a computer-readable program instruction configured to enable a processor to implement each aspect of the disclosure is stored.

The computer-readable storage medium may be a physical device capable of retaining and storing an instruction used by an instruction execution device. For example, the computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital Video Disk (DVD), a memory stick, a floppy disk, a mechanical encoding device, a punched card or in-slot raised structure with an instruction stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instruction described here may be downloaded from the computer-readable storage medium to each computing/processing device or downloaded to an external computer or an external storage device through a network such as the Internet, a Local Area Network (LAN), a Wide Area Network (WAN) and/or a wireless network. The network may include a copper transmission cable, optical fiber transmission, wireless transmission, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instruction configured to execute the operations of one or more embodiments may be an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instruction may be completely executed in a computer of a user or partially executed in the computer of the user, executed as an independent software package, executed partially in the computer of the user and partially in a remote computer, or executed completely in the remote server or a server. In case that the remote computer is involved, the remote computer may be concatenated to the computer of the user through any type of network including an LAN or a WAN, or, may be concatenated to an external computer (for example, concatenated by an Internet service provider through the Internet). In some embodiments, an electronic circuit such as a programmable logic circuit, an FPGA or a Programmable Logic Array (PLA) may be customized by use of state information of a computer-readable program instruction, and the electronic circuit may execute the computer-readable program instruction, thereby implementing each aspect of the disclosure.

Herein, each aspect of the disclosure is described with reference to flowcharts and/or block diagrams of the identity verification method, device (system) and computer program product according to one or more embodiments. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may further be loaded to the computer, the other programmable data processing device or the other device, so that a series of operating steps are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer program product according to multiple embodiments. On this aspect, each block in the flowcharts or the block diagrams may represent part of a module, a program segment or an instruction, and part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed substantially concurrently and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

Different embodiments may be combined without departing from logics, different embodiments are described with different emphases, and emphasized parts may refer to records in the other embodiments.

Each embodiment has been described above. The above descriptions are exemplary, non-exhaustive and also not limited to each disclosed embodiment. Many modifications and variations are apparent to those of ordinary skill in the art without departing from the scope and spirit of each described embodiment. The terms used herein are selected to explain the principle and practical application of each embodiment or technical improvements in the technologies in the market best or enable others of ordinary skill in the art to understand each embodiment disclosed herein.

### INDUSTRIAL APPLICABILITY

According to the disclosure, whether the collected face image of the object to be verified is included in the predetermined face image library may be determined to determine whether to acquire the target verification mode, in case that the face image is included in the predetermined face image library, the target verification mode is acquired, and the object to be verified is verified according to the target verification mode to obtain the verification result, thereby determining whether to open the door to allow access of the object to be verified that is successfully verified to a target region. Therefore, the security of admission or restriction for a target object may be improved.

1. A method for identity verification, comprising:
acquiring a face image of an object to be verified;
responsive to a condition that the face image is comprised in a predetermined face image library, acquiring a target verification mode for the object to be verified; and
verifying the object to be verified according to the target verification mode to obtain a verification result.

2. The method of claim 1, wherein acquiring the target verification mode for the object to be verified responsive to the condition that the face image is comprised in the predetermined face image library comprises:
in case that the face image is comprised in the predetermined face image library, determining verification according to identity information as the target verification mode.

3. The method of claim 1, wherein acquiring the target verification mode for the object to be verified responsive to the condition that the face image is comprised in the predetermined face image library comprises:
in case that the face image is comprised in the predetermined face image library, determining whether the face image is comprised in a target face image library to obtain a determination result; and
acquiring the target verification mode according to the determination result.

4. The method of claim 3, wherein acquiring the target verification mode according to the determination result comprises:
in case that the determination result is that the face image is not comprised in the target face image library, determining verification according to identity information as the target verification mode.

5. The method of claim 3, wherein acquiring the target verification mode according to the determination result comprises:
in case that the determination result is that the face image is comprised in the target face image library, determining verification according to identity information as the target verification mode.

6. The method of claim 2, wherein verifying the object to be verified according to the target verification mode to obtain the verification result comprises:
acquiring the identity information in an identification card of the object to be verified, and extracting a pre-stored face image from the identity information;
comparing the face image and the pre-stored face image to obtain a comparison result; and
obtaining the verification result according to the comparison result.

7. The method of claim 6, wherein acquiring the identity information in the identification card of the object to be verified comprises: triggering an information prompt, and starting reading the identity information in the identification card through a card reader.

8. The method of claim 7, wherein after triggering the information prompt and starting reading the identity information in the identification card through the card reader, the method further comprises:
for processing of reading the identity information through the card reader, starting timing processing to obtain a time length of reading the identity information through the card reader; and
responsive to the time length reaching first predetermined time, turning off the information prompt.

9. The method of claim 1, further comprising:
generating a control signal according to the verification result, and controlling access through a door according to the control signal.

10. A device for identity verification, comprising:
a processor; and
a memory configured to store instructions executable for the processor,
wherein the processor is configured to:
acquire a face image of an object to be verified;
responsive to a condition that the face image is comprised in a predetermined face image library, acquire a target verification mode for the object to be verified; and
verify the object to be verified according to the target verification mode to obtain a verification result.

11. The device of claim 10, wherein the processor is configured to:
in case that the face image is comprised in the predetermined face image library, determine verification according to identity information as the target verification mode.

12. The device of claim 10, wherein the processor is configured to:
in case that the face image is comprised in the predetermined face image library, determine whether the face image is comprised in a target face image library to obtain a determination result; and
acquire the target verification mode according to the determination result.

13. The device of claim 12, wherein the processor is configured to:
in case that the determination result is that the face image is not comprised in the target face image library, determine verification according to identity information as the target verification mode.

14. The device of claim 12, wherein the processor is configured to:
in case that the determination result is that the face image is comprised in the target face image library, determine verification according to identity information as the target verification mode.

15. The device of claim 11, wherein the processor is configured to:
acquire the identity information in an identification card of the object to be verified and extract a pre-stored face image from the identity information;
compare the face image and the pre-stored face image to obtain a comparison result; and
obtain the verification result according to the comparison result.

16. The device of claim 15, wherein the processor is configured to trigger an information prompt and start reading the identity information in the identification card through a card reader.

17. The device of claim 16, further comprising an information prompt control part, configured to:
for processing of reading the identity information through the card reader, start timing processing to obtain a time length of reading the identity information through the card reader; and
responsive to the time length reaching first predetermined time, turn off the information prompt.

18. The device of claim 10, wherein the processor is further configured to,
generate a control signal according to the verification result and control access through a door according to the control signal.

19. A non-transitory computer-readable storage medium having stored computer program instructions that when executed by a processor, implement a method for identity verification, the method comprising:
acquiring a face image of an object to be verified;
responsive to a condition that the face image is comprised in a predetermined face image library, acquiring a target verification mode for the object to be verified; and
verifying the object to be verified according to the target verification mode to obtain a verification result.
